(19) United States
(12) Patent Application Publication
(10) Pub. No.: US 2026/0321064 A1
(43) Pub. Date: Oct. 15, 2026

(54) ANALYZER MANAGEMENT SYSTEM

(71) Applicant: SHIMADZU CORPORATION, Kyoto (JP)

(72) Inventors: Kanimozhi SIVARAJAN, Singapore (SG); Sateesh naga vekata TUMMALA, Singapore (SG); Yoshiki TAINAKA, Singapore (SG)

(73) Assignee: SHIMADZU CORPORATION, Kyoto (JP)

(21) Appl. No.: 19/461,610

(22) Filed: Jan. 27, 2026

(30) Foreign Application Priority Data
Feb. 10, 2025 (SG) 10202500365X

(51) Int. Cl. G07C 3/06; G01N 35/00; G07C 3/04

(52) U.S. Cl. CPC G07C 3/06; G01N 35/00613; G01N 35/0092; G07C 3/04; G01N 2035/00891

(57) ABSTRACT

An analyzer management system for managing a plurality of analyzers of a plurality of types, includes: an information collector for collecting, from each analyzer, information concerning the timing of the initiation and completion of one unit of analysis performed in the analyzer; a preparation time setter for setting, for each type, an expected value of a preparation time required for the preparation for one unit of analysis; a time-of-use calculator for calculating, for each analyzer or for each type, the total of the time of use within a specified monitoring period, where the time of use is calculated by adding the expected value of the preparation time to the value of an analysis time calculated based on the information collected by the information collector; and a display processor for displaying, on a display section, the total of the time of use for each analyzer or for each type.

### TECHNICAL FIELD

The present invention relates to an analyzer management system for managing the operation of various types of analyzers, such as liquid chromatographs, gas chromatographs, mass spectrometers and ultraviolet-visible spectrophotometers.

### BACKGROUND ART

In general, pharmaceutical makers, chemical/chemical-products makers, companies offering entrusted analysis services, and similar organizations have various types of analyzers employing various analytical techniques, and the number of analyzers they possess is also considerably large. Of course, not all analyzers possessed by those companies or organizations are frequently used; it is often the case that there are analyzers which are infrequently used or rarely used. Therefore, in those companies or organizations, there has been strong demand for grasping the operational status of the analyzers in their possession as accurately as possible in order to efficiently operate a large number of analyzers, effectively use the installation spaces for the analyzers, as well as prepare a plan for the introduction or replacement (or the like) of analyzers.

The failure or malfunction of an analyzer often results from its deterioration over time. Therefore, it has been common practice to obtain information about the accumulated time of use of each individual analyzer and issue an alert based on that time of use, such as a message which notifies that the time for the replacement of a specific part is approaching. In order to obtain information about the accumulated time of use of an analyzer, in a conventional analyzing system, a control-and-management device connected to the analyzer collects the information concerning the timing of the initiation and completion (e.g., the beginning and ending times) of an analysis in the analyzer and calculates the analysis time from that information. Another type of system, an example of which is described in Patent Literature 1, has also been known which detects the consumed amount of the power supplied from a power source to each individual analyzer and determines the analysis time of each of the units constituting the analyzer based on that power consumption. This system can predict the analysis time of an analyzer even when the control-and-management device cannot collect the information concerning the timing of the initiation and completion of an analysis from the analyzer.

### CITATION LIST

### Patent Literature

[Patent Literature 1] WO 2018/020655 A

### SUMMARY OF INVENTION

### Technical Problem

The previously described conventional system can obtain information about the period of time during which the analyzer was actually performing an analysis on a sample. On the other hand, when an analysis is to be performed in an analyzer, an analysis operator needs to perform various preparatory tasks on the analyzer before the analysis, and the analysis operator occupies the analyzer also during those preparatory tasks. Possible examples of such preparatory tasks include the task of setting a sample to be analyzed in the analyzer, checking the readiness of the necessary consumables for the analysis (e.g., various reagents, solutions or gases) and replenishing them as needed, or checking the state of the necessary parts for the analysis and replacing or cleaning a part as needed.

While analysis operator A is performing such preparatory tasks for an analysis at an analyzer, although no actual analysis is being performed, the analyzer is unavailable for another analysis operator B, and therefore, the analyzer can be considered to be practically used by analysis operator A. Therefore, for an administrator of the analyzers and the analyzing system, it is preferable that the period of time required for the preparatory tasks should also be treated as the time of use of the analyzer when grasping the usage status of the analyzer. However, the conventional analyzing system has the problem that, while allowing for the determination of the analysis time of each individual analyzer, the system does not always allow for the appropriate determination of the time of use including the preparation time during which the analyzer is not performing an analysis operation.

The present invention has been developed in view of this problem, and its primary objective is to provide an analyzer management system which allows for the appropriate determination of the time of use of an analyzer for various types of analyzers, including the period of time for preparatory tasks (or the like) other than the period of time during which the analyzer is actually performing an analysis.

### Solution to Problem

One mode of the present invention developed for solving the previously described problem is an analyzer management system configured to manage a plurality of analyzers of a plurality of types, the system including:
an information collector configured to collect, from each of the plurality of analyzers, information concerning the timing of the initiation and completion of one unit of analysis performed in the analyzer;
a preparation time setter configured to set, for each of the plurality of types, an expected value of a preparation time required for the preparation for one unit of analysis;
a time-of-use calculator configured to calculate, for each of the plurality of analyzers or for each of the plurality of types, the total of the time of use within a specified monitoring period, where the time of use is calculated by adding the expected value of the preparation time set by the preparation time setter to the value of an analysis time calculated based on the information collected by the information collector; and
a display processor configured to display, on a display section, the total of the time use for each of the plurality of analyzers or for each of the plurality of types calculated by the time-of-use calculator.

### Advantageous Effects of Invention

The previously described mode of the analyzer management system according to the present invention can inform the user of the total of the effective time of use of the analyzer including not only the analysis time during which an analysis is actually performed on a sample but also the period of time required for preparatory tasks for the analysis for each of the plurality of analyzers or for each of the plurality of types. Accordingly, the user can properly grasp the usage status of each of the plurality of analyzers or each of the plurality of types within a desired monitoring period, such as one week, one month or six months, with the result that the user can perform an efficient operation and management of the entire analyzing system, for example, by reducing the number of analyzers that are infrequently used, or conversely, by planning an additional introduction of an analyzer that is frequently used.

### BRIEF DESCRIPTION OF DRAWINGS

FIG. 1 An overall configuration diagram of one embodiment of an analyzing system including an analyzer management system according to the present invention.

FIG. 2 A schematic block configuration diagram of a management PC in the analyzing system of the present embodiment.

FIG. 3 A diagram showing one example of the time-of-use monitoring setting screen.

FIG. 4 A diagram showing one example of the time-of-use monitoring result display (tabular view) screen.

FIG. 5 A diagram showing one example of the time-of-use monitoring result display (graph view for each type) screen.

FIG. 6 A diagram showing a transition state of a portion of the time-of-use monitoring result display screen shown in FIG. 5.

FIG. 7 A diagram showing one example of the time-of-use monitoring result display (graph view for each instrument) screen.

### DESCRIPTION OF EMBODIMENTS

### Supplementary Description of Previously Described Mode

The “analyzer” in the previously described mode of the analyzer management system according to the present invention is an instrument configured to perform a predetermined physical or chemical analysis on a sample or specimen. The “type” of analyzer typically or normally means an analytical technique. In that case, different types of analyzers can be paraphrased as analyzers employing different analytical techniques. Accordingly, for example, it is possible to say that a liquid chromatograph apparatus, gas chromatograph apparatus, liquid chromatograph mass spectrometer, gas chromatograph mass spectrometer, ultraviolet-visible spectrophotometer, Fourier transform infrared spectrophotometer and X-ray analyzer are different types of analyzers from each other. Of course, as will be described later, it is possible to further divide the analytical techniques into subgroups for determining the same type or different types of analyzers.

The “one unit of analysis” in the previously described mode may be an analysis for one sample or an analysis for a plurality of samples. For example, in the case of a batch process in which an analysis is automatically and sequentially performed for a plurality of prepared samples under previously set conditions, the analysis performed for the plurality of samples in the single batch process corresponds to one unit of analysis.

The “preparation time required for the preparation for one unit of analysis” in the previously described mode is typically the period of time required for preparatory tasks, such as the setting of a sample to be analyzed in the analyzer, although it may additionally include the period of time required for a post-analysis task that must be performed for the next analysis immediately after the completion of one analysis.

### Configuration of Analyzing System as One Embodiment

One embodiment of an analyzing system including an analyzer management system according to the present invention is hereinafter described with reference to the attached drawings.

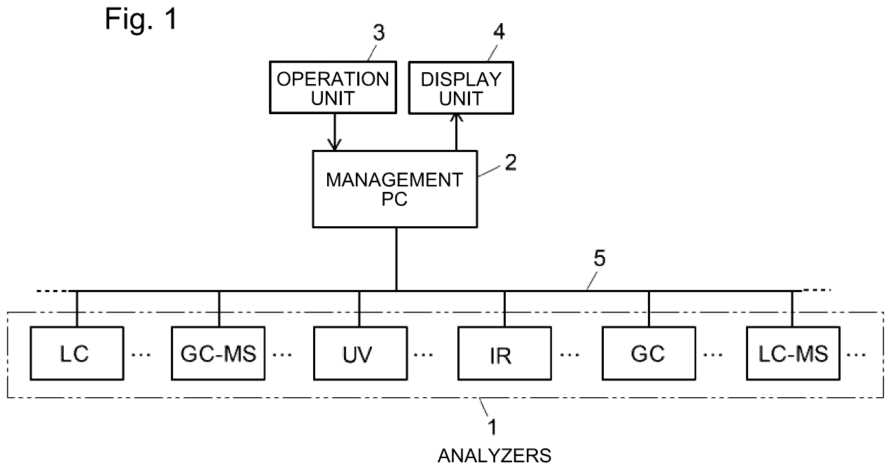

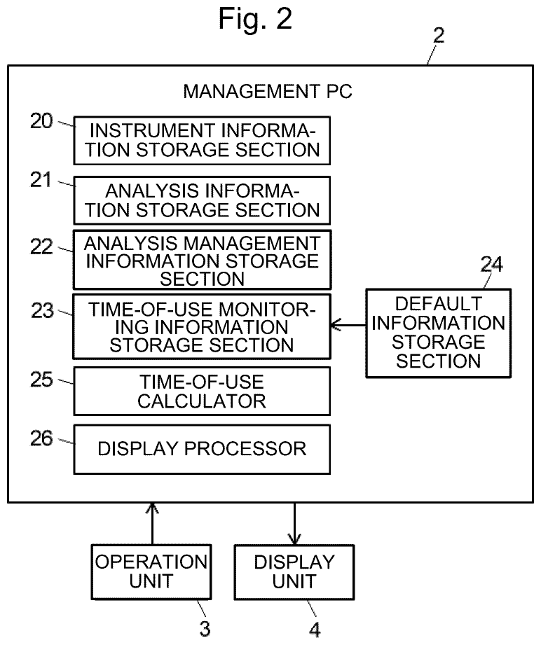

FIG. 1 is an overall configuration diagram of the analyzing system of the present embodiment. FIG. 2 is a schematic block configuration diagram of a management PC in FIG. 1.

As shown in FIG. 1, this analyzing system includes a management PC (personal computer) 2 and a plurality of analyzers 1. Here, the analyzers 1 are a liquid chromatograph (LC), gas chromatograph (GC), liquid chromatograph mass spectrometer (LC-MS), gas chromatograph mass spectrometer (GC-MS), ultraviolet-visible spectrophotometer (UV) and Fourier transform infrared spectrophotometer (IR), each of which is a different type of analyzer. It should be noted that the types of analyzers 1 are not limited to these types. Although one instrument is shown here for each of the plurality of types of analyzer 1, the number of analyzers 1 may be two or more for each type.

The management PC 2 is connected to the analyzers 1 via a communication line 5. The communication line 5 only needs to allow for the transmission of data, and it certainly may be wired or wireless. An operation unit 3 which includes a keyboard and a mouse (and the like) as well as a display unit 4 which is a liquid display (or the like) are connected to the management PC 2. It is natural that the operation unit 3 may be a touch pad. The management PC 2 may be constructed using a single computer, although it may also consist of a plurality of computers.

In the analyzing system shown in FIG. 1, each of the plurality of analyzers 1 is independently used for an analysis. The management PC 2 may additionally have the function of a collective, i.e., centralized control of the operation of each of the plurality of analyzers 1 as well as the function of a centralized processing or management of the data acquired through the analyses by those analyzers 1. However, having those functions is not essential for the present embodiment. In the analyzing system of the present embodiment, the management PC 2 has the function of collectively managing the time of use of each of the plurality of analyzers 1. This function is hereinafter described.

It should be noted that, in the following description, for convenience, an individual who takes charge of an analysis at an analyzer 1 is called an “analysis operator”, while an individual who manages the analyzers or analyzing system is called an “administrator”, although there may be the case where the same individual acts as both the analysis operator and the administrator. The entire group of individuals using the analyzers or analyzing system, including the analysis operator and the administrator, may be referred to as the “user”.

### Configuration and Schematic Operation of Management PC

As shown in FIG. 2, the management PC 2 includes, as its functional blocks, an instrument information storage section 20, analysis management information collector 21, analysis management information storage section 22, time-of-use monitoring information setter 23, default information storage section 24, time-of-use calculator 25, display processor 26 and the likes. These functions can be realized by a piece of dedicated application software (computer program) installed on the management PC 2 and executed on the same computer. In that case, the application software may be provided as one aggregate product or as a plurality of separate components.

In the instrument information storage section 20, a set of instrument information including the type of analyzer, instrument name (or number or similar information for identifying each of the plurality of analyzers) and other items are stored for all analyzers 1 to be used in the present analyzing system. The registration of those items of instrument information is normally performed by an administrator. Each individual analyzer 1 can be identified by this registered instrument information.

When an analysis operator is going to perform an analysis using an analyzer 1, the analysis operator should set one or more samples to be analyzed in the analyzer 1 and subsequently set or select analysis conditions before issuing an analysis-execution command to initiate the analysis. Of course, it is also possible to reserve an analysis execution time the in a control PC provided for controlling the analyzer 1 (the management PC 2 may also act as this PC) so that the analysis will be automatically initiated at the reserved time.

When an analysis is initiated in the analyzer 1, a piece of information indicating the initiation of the analysis is transmitted from the analyzer 1 to the management PC 2. When an analysis is completed, a piece of information indicating the completion of the analysis is transmitted from the analyzer 1 to the management PC 2. The transmission of the information indicating the timing of the initiation and completion of the analysis transmitted from the analyzer 1 to the management PC 2 is similarly performed in whichever analyzer 1 the analysis is performed.

The analysis control information collector 21 in the management PC 2 collects, from each of the plurality of analyzers 1, information indicating the timing of the initiation and completion of one unit of analysis, which is typically information indicating the beginning and ending times. Referring to the instrument information stored in the instrument information storage section 20, the analysis management information collector 21 identifies the analyzer 1 and stores, for each of the plurality of analyzers 1, the beginning and ending times of one unit of analysis as log information in the analysis management information storage section 22. Accordingly, every time one unit of analysis is carried out in the analyzer 1, the beginning and ending times of that one unit of analysis are accumulated as log information in the analysis management information storage section 22. As noted earlier, the “one unit of analysis” in the present context may be an analysis for one sample or a series of analyses continuously and automatically performed for a plurality of samples.

When an administrator wants to check the usage status of the analyzers within a desired monitoring period, the administrator should perform a predetermined operation using the operation unit 3. In response to this operation, the time-of-use monitoring information setter 23 sets, for example, calculation information required for calculating the time of use within the monitoring period. The calculation information includes, for each of the plurality of types, an expected value of a preparation time for performing preparatory tasks that are needed before an analysis, such as the setting of a sample. As will be described later, it is possible to allow the administrator to enter the expected value of the preparation time. However, it is also possible to directly use, as the expected value of the preparation time, a default value previously stored in the default information storage section 24.

After the calculation information has been set and the monitoring period for which the time of use is to be determined has been specified, the time-of-use calculator 25 obtains log information corresponding to that monitoring period from the analysis management information storage section 22. Using the beginning and ending times of the analysis in each of the plurality of analyzers 1 included in the log information, the time-of-use calculator 25 calculates the actual analysis time in one unit of analysis. The time-of-use calculator 25 adds the expected value of the preparation time corresponding to the type of instrument to which the analyzer belongs, to the calculated value of the analysis time corresponding to the one unit of analysis, to determine the time of use of the analyzer in that one unit of analysis. In this manner, the time-of-use calculator 25 determines the total of the time of use for each of the plurality of analyzers 1 within the monitoring period and further calculates the aggregate total of the time of use for each of the plurality of types by adding the totals of the time of use of the analyzers involved.

It should be noted that the same preparation time is equally applied to the same type of analyzers 1, and therefore, it is evident that the total of the time of use for each of the plurality of analyzers 1 or for each of the plurality of types of analyzer 1 may also be calculated by determining the total number of times of the analysis for each of the plurality of analyzers 1 or for each of the plurality of types of analyzer 1, multiplying that total number of times by the preparation time to obtain the total of the preparation time, and adding that total of the preparation time to the total of the net analysis time, rather than determining the time of use for each unit of analysis in the previously described manner.

The display processor 26 shows the total of the time of use for each of the plurality types of analyzer 1 within the monitoring period, calculated by the time-of-use calculator 25, in a predetermined format on the screen of the display unit 4 to provide the calculated value to the administrator.

The analyzing system of the present embodiment can display, on the screen of the display unit 4, the total of the time of use within the monitoring period, e.g., a one-month period, for each of the plurality of types, such as the liquid chromatograph or gas chromatograph. The time of use includes not only the analysis time during which an analysis was actually performed in each of the plurality of analyzers 1; it also includes the period of time for the analysis operator to set a sample to be analyzed as well as the preparation time for the analysis operator to check various consumables and parts necessary for the analysis and perform appropriate tasks, such as the replenishment as needed. Although this preparation time included in the time of use is a mere prediction value expected beforehand and is not the period of time actually required for the preparatory tasks, the administrator can set an appropriately expected value of the preparation time for each of the plurality of types, taking into account the actual situation at the site of the analysis, such as the working procedure, content of work and level of skill of the analysis operator, so as to obtain the total of the time of use with a sufficient level of accuracy for the purpose of grasping the usage status of the analyzers.

### Specific Processing Operation in Time-of-Use Monitoring

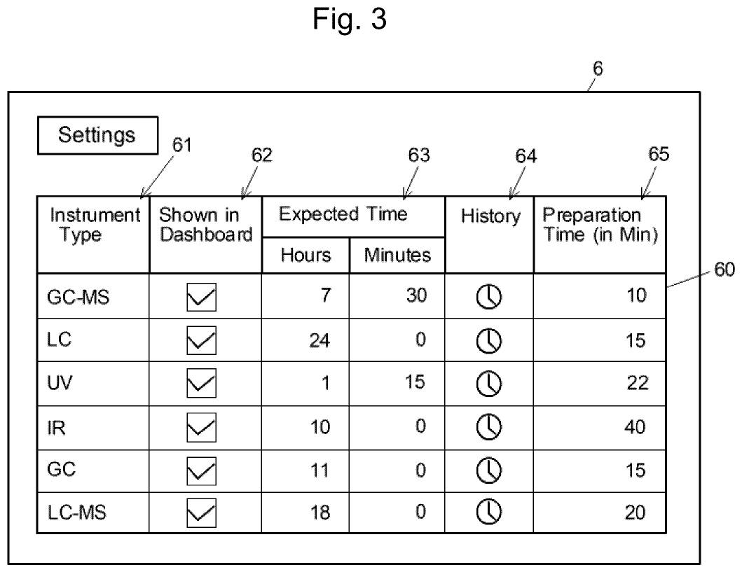

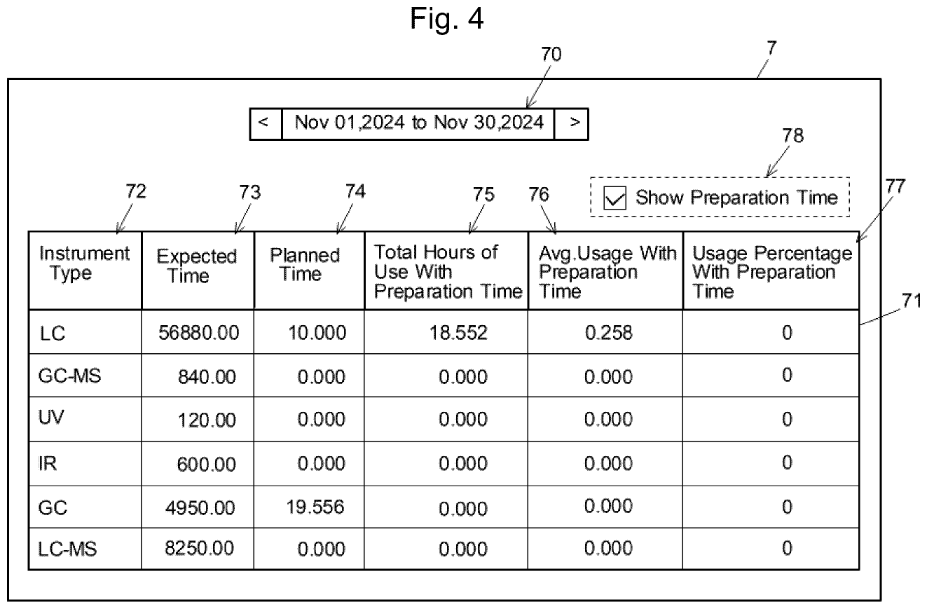

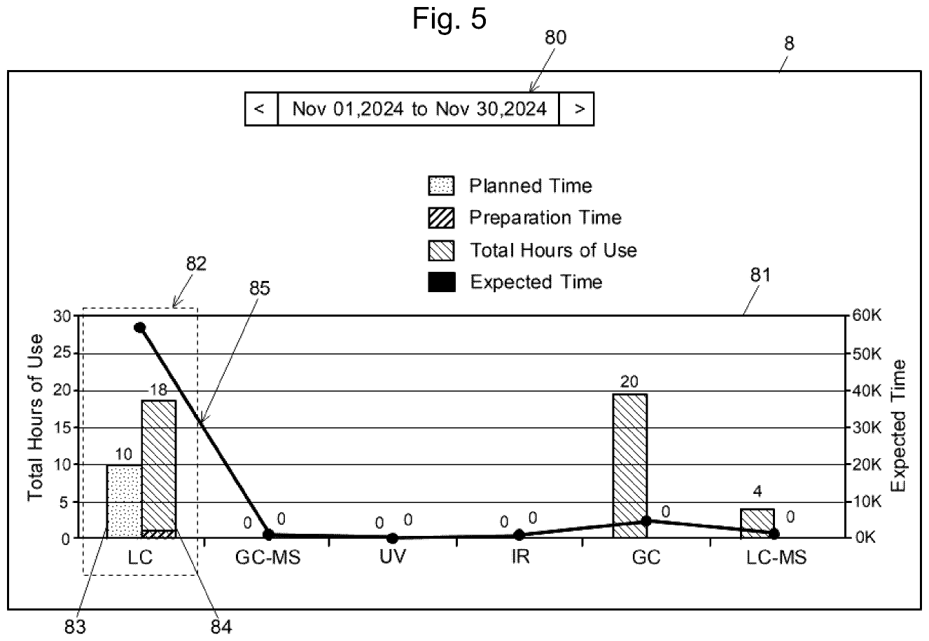

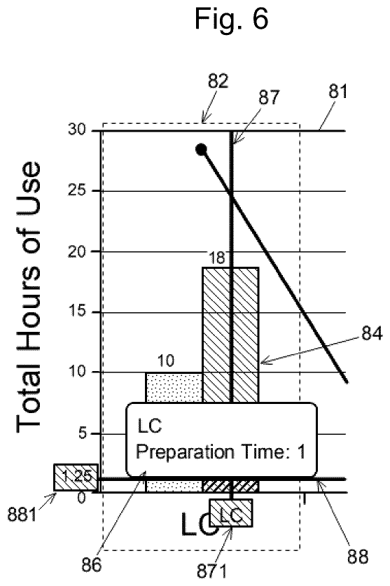

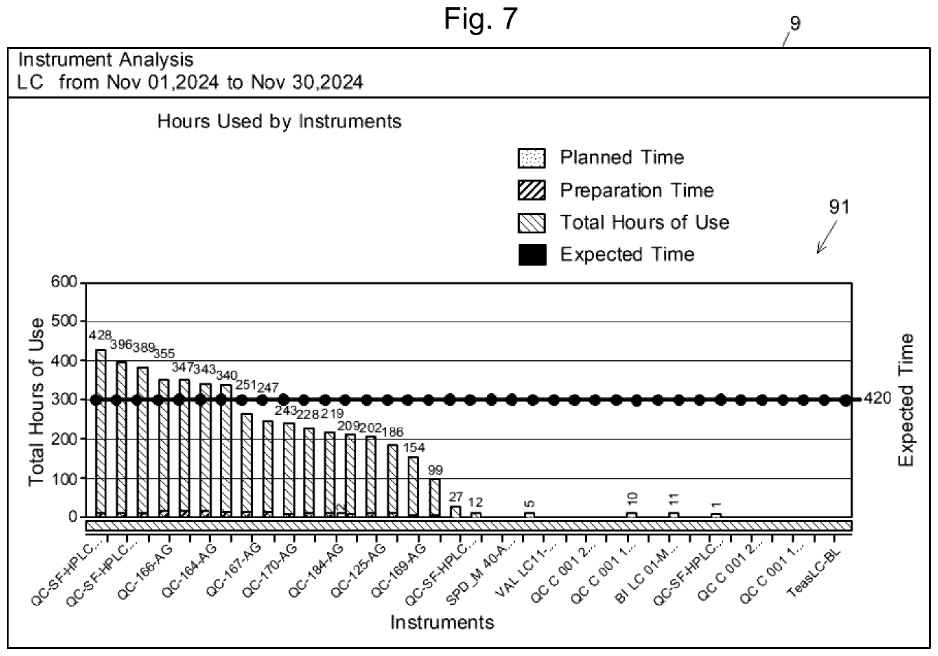

One example of the processing operation in the previously described time-of-use monitoring is specifically described with reference to FIGS. 3-7. FIG. 3 is a diagram showing one example of the time-of-use monitoring setting screen, FIG. 4 is a diagram showing one example of the time-of-use monitoring result display (tabular view) screen, FIG. 5 is a diagram showing one example of the time-of-use monitoring result display (graph view for each type) screen, FIG. 6 is a diagram showing a transition state of a portion of the time-of-use monitoring result display screen shown in FIG. 5, and FIG. 7 is a diagram showing one example of the time-of-use monitoring result display (graph view for each instrument) screen.

When the administrator has performed a predetermined operation on the operation unit 3, the time-of-use monitoring information setter 23 shows the time-of-use monitoring setting screen 6 as shown in FIG. 3 on the screen of the display unit 4. As shown in FIG. 3, a setting table 60 is placed in the time-of-use monitoring setting screen 6. The setting table 60 has the following items horizontally arranged: “Instrument Type” 61, “Shown in Dashboard” 62, “Expected Time” 63, “History” 64 and “Preparation Time (in Min)” 65.

“Instrument Type” 61 is the field which shows the type of analyzer, in which the type of analyzer based on the instrument information stored in the instrument information storage section 20 is shown in each of the vertically arrayed cells. “Shown in Dashboard” 62 is the field which contains a checkbox for specifying whether or not the result for the type of analyzer shown in “Instrument Type” 61 should be displayed. In the example of FIG. 3, all types of analyzers have their respective boxes checked, so that the result for all of those types of analyzers should be displayed. If there is a type of analyzer for which the result does not need to be displayed, the box in “Shown in Dashboard” 62 can be unchecked. “Expected Time” 63 is the field for setting, for each of the plurality of types, the total time of use expected, for example, from a rough estimation of the amount of use. “Preparation Time (in Min)” 65 is the field for setting an expected value of the preparation time for one unit of analysis described earlier. “History” 64 is the field for viewing the operational history, such as the date and time of an input or modification of “Preparation Time (in Min)” 65 or “Expected Time” 63. When the mark shown in this field is clicked by the administrator, the operational history is shown in a pop-up.

In the initial state in which the analyzing system of the present embodiment is used for the first time, the default value concerning the expected value of the preparation time stored in the default information storage section 24 is shown in each cell of “Preparation Time (in Min)” 65. For example, the default values are previously set as normal values by the manufacturer providing the present analyzing system. The administrator checks each default value and leaves it intact if no modification is required or rewrites the expected value of the preparation time if modification is required. In order to calculate the time of use as accurately as possible, it is preferable to set, as noted earlier, an appropriately expected value of the preparation time according to the actual situation for each user.

With the calculated information thus set on the time-of-use monitoring setting screen 6, when the administrator has performed a predetermined operation using the operation unit 3, the display processor 26 shows, as described earlier, the time-of-use monitoring result display (tabular view) screen 7, as shown in FIG. 4 for example, on the screen of the display unit 4. This time-of-use monitoring result display (tabular view) screen 7 has a monitoring-period specifying section 70 in its upper portion. In this monitoring-period specifying section 70, the administrator sets the period of time within which the time-of-use information is needed. In the example of FIG. 4, a one-month period from Nov. 1, 2024 to Nov. 30, 2024 is set as the monitoring period. Any period of time can be set, such as one week, one month, six months or one year.

After the monitoring period has been set, the time-of-use calculator 25 computes the total of the time of use for each of the plurality of analyzers 1 as well as for each of the plurality of types of analyzer 1, and the display processor 26 shows the calculated result in the result table 71 within the time-of-use monitoring result display (tabular view) screen 7.

In this result table 71, the items “Instrument Type” 72 and “Expected Time” 73 are identical to “Instrument Type” 61 and “Expected Time” 63 in FIG. 3.

“Planned Time” 74 is the field which shows the reserved time for the analysis for each of the plurality of types of analyzer 1. When there is an analyzer 1 which has been reserved for an analytical task in the previously described manner, the analysis management information collector 21 additionally collects the reservation information and stores it in the analysis management information storage section 22. The time-of-use calculator 25 computes the total of the reserved time based on the stored reservation information and shows it in the field of “Planned Time” 74. “Total Hours of Use With Preparation Time” 75 is the field which shows the total of the time of use, determined by the computation by the time-of-use calculator 25, including the preparation time for each of the plurality of types of analyzer 1. In the example shown in FIG. 4, only the liquid chromatograph (LC) has a total time of use of 18.552 hours.

“Avg. Usage With Preparation Time” 76 is the field which shows an average of the time of use per one unit of analysis for each of the plurality of types of analyzer 1. The average equals the numerical value in the field of “Total Hours of Use With Preparation Time” 75 divided by the number of times of the analysis (number of units). “Usage Percentage With Preparation Time” 77 is a numerical value which shows, for each of the plurality of types, the percentage of the numerical value shown in “Total Hours of Use With Preparation Time” 75 to the numerical value shown in “Expected Time” 73.

Additionally, a “Show Preparation Time” checkbox 78 is provided at the upper right portion of the result table 71. In the example shown in FIG. 4, since this box 78 is checked, the calculated result of the time of use including the preparation time is shown in the result table 71. If the administrator has performed an operation for unchecking the “Show Preparation Time” checkbox 78, the content displayed in the result table 71 is changed to the calculated result of the net analysis time exclusive of the preparation time. Specifically, “Total Hours of Use With Preparation Time” 75 in FIG. 4 is changed to “Total Hours of Use Without Preparation Time”, while “Avg. Usage With Preparation Time” 76 and “Usage Percentage With Preparation Time” 77 are also similarly changed to “Avg. Usage Without Preparation Time” and “Usage Percentage Without Preparation Time”, and the numerical values corresponding to the respective items are displayed. Thus, the display in the result table 71 can be switched between the time of use inclusive of the preparation time and the time of use exclusive of the preparation time (i.e., the net analysis time).

When the administrator has performed a predetermined operation, for example, on the time-of-use monitoring result display (tabular view) screen 7, the display processor 26 changes the display on the screen of the display unit 4 to the time-of-use monitoring result display (graph view for each type) screen 8 as shown in FIG. 5. In the time-of-use monitoring result display (graph view for each type) screen 8, a graph 81 is placed which shows, in the form of a bar chart, the total of the time of use for each of the plurality of types within the specified monitoring period. This graph 81 also shows the total of the time of use (Total Hours of Use) and that of the preparation time (Preparation Time), as well as the “Planned Time” and the “Expected Time” described earlier. For example, in the graph display area 82 for the liquid chromatograph (LC), a bar chart 84 showing the “Total Hours of Use” and a bar chart 83 showing the “Planned Time” are displayed side by side, and a plot-and-line graph 85 showing the “Expected Time” are also shown.

The time-of-use monitoring result display (graph view for each type) screen 8 allows for the intuitive recognition of such features as the difference in the time of use for each of the plurality of types of analyzer 1. Although the graph 81 on the time-of-use monitoring result display (graph view for each type) screen 8 allows for rough comprehension, it is difficult to read the total of the preparation time and other numerical values. Accordingly, when it is necessary to know the total of the preparation time (“Preparation Time”) in detail, the administrator performs appropriate operation using a mouse or similar device in the operation unit 3 to move the cursor into an area above the “Preparation Time” of the bar chart 84 on the time-of-use monitoring result display (graph view for each type) screen 8. Then, as shown in FIG. 6, a pop-up window 86 showing an approximate total of the preparation time is temporarily displayed. Additionally, a vertical line 84 and a horizontal line 88 are superposed on the bar chart 84, with a text 871 showing the type of analyzer superposed on an extension of the vertical line 87 as well as another text 881 showing the exact total of the preparation time superposed on an extension of the horizontal line 88. With the help of such a display, the administrator can easily read detailed numerical values and other information in the graph 81.

The present analyzing system can also display the total of the time of use for each individual analyzer other than the total of the time of use for each of the plurality of types as shown in FIGS. 4 and 5. That is to say, for example, when the administrator has performed a predetermined operation on the time-of-use monitoring result display (graph view for each type) screen 8 through the operation unit 3, the display processor 26 shows the time-of-use monitoring result display (graph view for each instrument) screen 9 as shown in FIG. 7 on the screen of the display unit 4. In the time-of-use monitoring result display (graph view for each instrument) screen 9 shown in FIG. 7, a graph 91 is displayed which shows the total of the time of use, within the monitoring period, of each individual liquid chromatograph registered as a liquid-chromatograph type of analyzer. That is to say, the instrument name of each liquid chromatograph is shown on the horizontal axis of the graph 91, and a bar chart and a line graph similar to those in FIG. 5 are shown for each instrument name.

This allows for not only the general comprehension of the usage status for each of the plurality of types, such as the liquid chromatograph, but also the detailed grasping of the usage status for each individual analyzer. For example, liquid chromatographs significantly vary in model, performance or specifications. Therefore, it is often the case that the instruments placed on the site of the analysis include an instrument which is an old model and hardly usable due to its low performance or one whose specifications do not easily agree with the purpose of the analysis. Visualizing the usage status of the individual analyzers in an easy-to-understand fashion in the previously described manner allows the user to locate an instrument whose use frequency is extremely low or one which has not been recently used at all.

In the graph 91 shown in FIG. 7, the analyzers are arranged from left end toward right in descending order of the total of the time of use. This arrangement is a mere example and may be appropriately changed; for example, they may be arranged in descending order of the total of the preparation time or by instrument name. In other words, a sorting function may be provided.

As described so far, the analyzing system of the present embodiment can present a considerably accurate total of the time of use for each of the plurality of types or for each individual analyzer within a monitoring period desired by the administrator. Therefore, even when there are many analyzers, or even when there are many types of analyzers, the administrator can properly grasp the usage status of the analyzers and appropriately perform the operation and management of the analyzers.

### Modified Examples

In the previous description, the analyzers are classified into general types, such as the liquid chromatograph or gas chromatograph. It is also possible to divide the types of analyzers into subgroups. For example, in the case of liquid chromatograph mass spectrometers, there may be a difference in the purpose of use between an instrument in which the mass spectrometer is a single type of quadrupole mass spectrometer and an instrument in which the mass spectrometer is a triple quadrupole mass spectrometer or quadrupole time-of-flight mass spectrometer capable of an MS/MS analysis. Therefore, although the former and latter instruments are both categorized as liquid chromatograph mass spectrometers, it may possibly be convenient to handle them as different types of analyzers in the present context. This is not limited to mass spectrometers but similarly applies to analyzers employing other analytical techniques. In summary, the types of analyzers in the present context can be considered as nothing more than conveniently defined types. Accordingly, it is possible to allow the user to appropriately define a group of analyzers that should be treated as the same type of analyzer.

Additionally, the previous description assumed that the preparation time was a period of time required for preparing for an analysis, such as the task of setting a sample to be analyzed or checking consumables. Depending on the type of analyzer or the procedure of the analytical task, the analysis operator may perform some tasks related to the analyzer after the completion of one unit of analysis, such as the removal or cleaning of a specific part, so that the next analysis can be smoothly performed. Since such a task is practically equivalent to the use of the analyzer, it is naturally possible to consider that the period of time for performing such a post-analysis task may also be included in the previously described preparation time. In other words, any period of time which is not included in the analysis time during which an analysis is being performed in an analyzer may be included in the preparation time if that period of time is required for a task which is related to one unit of analysis and cannot be performed without using the analyzer, or for a task which practically occupies the analyzer.

It should be noted that the previously described embodiment and modified examples are also mere examples of the present invention and will evidently be included within the scope of claims of the present application even when an appropriate change, addition or modification is additionally made within the spirit of the present invention.

### Various Modes

A person skilled in the art can understand that the previously described illustrative embodiment is a specific example of the following modes of the present invention.

(Clause 1) One mode of the present invention is an analyzer management system configured to manage a plurality of analyzers of a plurality of types, the system including:
an information collector configured to collect, from each of the plurality of analyzers, information concerning the timing of the initiation and completion of one unit of analysis performed in the analyzer;
a preparation time setter configured to set, for each of the plurality of types, an expected value of a preparation time required for the preparation for one unit of analysis;
a time-of-use calculator configured to calculate, for each of the plurality of analyzers or for each of the plurality of types, the total of the time of use within a specified monitoring period, where the time of use is calculated by adding the expected value of the preparation time set by the preparation time setter to the value of an analysis time calculated based on the information collected by the information collector; and
a display processor configured to display, on a display section, the total of the time use for each of the plurality of analyzers or for each of the plurality of types calculated by the time-of-use calculator.

The analyzer management system according to Clause 1 can present, to the user, the total of the effective time of use of the analyzer for each of the plurality of analyzers or for each of the plurality of types, including not only the analysis time during which an analysis is actually performed but also the period of time required for preparatory tasks for the analysis. Accordingly, the user can grasp the usage status of each of the plurality of analyzers or each of the plurality of types within a desired monitoring period, such as one week, one month or six months. By utilizing the information thus obtained, the user can perform an efficient operation and management of the entire analyzing system, for example, by reducing the number of analyzers that are infrequently used, removing an unused analyzer, or additionally introducing an analyzer that is frequently used.

(Clause 2) In the analyzer management system according to Clause 1, the preparation time setter may be configured to set the expected value of the preparation time according to an input operation or modifying operation by a user.

In the analyzer management system according to Clause 1, the preparation time setter may set, as the expected value of the preparation time, a value previously specified for each of the plurality of analyzers or for each of the plurality of types (default value). In the analyzer management system according to Clause 2, the user is allowed to directly input the expected value of the preparation time or to appropriately modify the default value or an already set value.

The period of time required for the preparation of samples or other preparatory tasks before an analysis considerably varies depending on the procedure and method of the tasks. To deal with this problem, the analyzer management system according to Clause 2 allows the user to appropriately set the expected value of the preparation time taking into account the working procedure, past records and other factors. Therefore, the time of use for each of the plurality of analyzers or for each of the plurality of types can be more accurately determined.

(Clause 3) In the analyzer management system according to Clause 1 or 2, the display processor may be configured to simultaneously or selectively display, for each of the plurality of analyzers or for each of the plurality of types, the total of the time of use and the total of a net analysis time exclusive of the preparation time.

The analyzer management system according to Clause 3 allows the user to view not only the total of the time of use within a desired monitoring period but also the total of the analysis time exclusive of the preparation time as needed.

(Clause 4) In the analyzer management system according to one of Clauses 1-3, the information collector may be configured to additionally collect, for each of the plurality of analyzers, information of a reserved time during which the analyzer is reserved for an analysis, the time-of-use calculator may be configured to additionally calculate the total of the reserved time within the monitoring period for each of the plurality of analyzers or for each of the plurality of types, and the display processor may be configured to display the total of the reserved time along with the total of the time of use for each of the plurality of analyzers or for each of the plurality of types.

The analyzer management system according to Clause 4 displays the total of the reserved time for each of the plurality of analyzers or for each of the plurality of types. Therefore, for example, the user can understand how many analyses are performed without reservations as well as detect a situation in which the number of actually performed analyses is considerably fewer than the number of reservations for the analyses. From this information, the appropriateness or validity of the analysis reservation system or reservation method can be verified.

(Clause 5) In the analyzer management system according to one of Clauses 1-4, the plurality of types may include one or more types selected from a group consisting of liquid chromatographs, gas chromatographs, liquid chromatograph mass spectrometers, gas chromatograph mass spectrometers, ultraviolet-visible spectrophotometers and infrared spectrophotometers.

### REFERENCE SIGNS LIST

1 . . . Analyzer
2 . . . Management PC
20 . . . Instrument Information Storage Section
21 . . . Analysis Control Information Collector
22 . . . Analysis Management Information Storage Section
23 . . . Time-of-Use Monitoring Information Setter
24 . . . Default Information Storage Section
25 . . . Time-of-Use Calculator
26 . . . Time-of-Use Monitoring Result Display Processor
3 . . . Operation Unit
4 . . . Display Unit
5 . . . Communication Line

1. An analyzer management system configured to manage a plurality of analyzers of a plurality of types, the system comprising:
an information collector configured to collect, from each of the plurality of analyzers, information concerning a timing of an initiation and completion of one unit of analysis performed in the analyzer;
a preparation time setter configured to set, for each of the plurality of types, an expected value of a preparation time required for a preparation for one unit of analysis;
a time-of-use calculator configured to calculate, for each of the plurality of analyzers or for each of the plurality of types, a total of a time of use within a specified monitoring period, where the time of use is calculated by adding the expected value of the preparation time set by the preparation time setter to a value of an analysis time calculated based on the information collected by the information collector; and
a display processor configured to display, on a display section, the total of the time use for each of the plurality of analyzers or for each of the plurality of types calculated by the time-of-use calculator.

2. The analyzer management system according to claim 1, wherein the preparation time setter is configured to set the expected value of the preparation time according to an input operation or modifying operation by a user.

3. The analyzer management system according to claim 1, wherein the display processor is configured to simultaneously or selectively display, for each of the plurality of analyzers or for each of the plurality of types, the total of the time of use and the total of a net analysis time exclusive of the preparation time.

4. The analyzer management system according to claim 1, wherein the information collector is configured to additionally collect, for each of the plurality of analyzers, information of a reserved time during which the analyzer is reserved for an analysis, the time-of-use calculator is configured to additionally calculate a total of the reserved time within the monitoring period for each of the plurality of analyzers or for each of the plurality of types, and the display processor is configured to display the total of the reserved time along with the total of the time of use for each of the plurality of analyzers or for each of the plurality of types.

5. The analyzer management system according to claim 1, wherein the of the plurality of types include one or more types selected from a group consisting of liquid chromatographs, gas chromatographs, liquid chromatograph mass spectrometers, gas chromatograph mass spectrometers, ultraviolet-visible spectrophotometers and infrared spectrophotometers.
